(19) United States
(12) Patent Application Publication
(10) Pub. No.: US 2026/0076480 A1
(43) Pub. Date: Mar. 19, 2026

(54) FILTER INSTALLATION BRACKET AND CABINET APPARATUS USING THE SAME

(71) Applicant: Taiwan Semiconductor Manufacturing Company, Ltd., Hsinchu (TW)

(72) Inventors: Ke-Chang LU, Hsinchu (TW); Yi Xian LI, Hsinchu (TW); Chia Pao CHANG, Hsinchu (TW)

(73) Assignee: Taiwan Semiconductor Manufacturing Company, Ltd., Hsinchu (TW)

(21) Appl. No.: 18/888,433

(22) Filed: Sep. 18, 2024

(51) Int. Cl. A47B 97/00; B01D 35/30; F16M 13/02

(52) U.S. Cl. CPC A47B 97/00; B01D 35/306; F16M 13/02

(57) ABSTRACT

A filter installation bracket includes a first linkage and a second linkage. The first linkage is configured to fix a filter holder and comprising a first sliding portion. The second linkage includes a second sliding portion. The second sliding portion is slidably connected with the first sliding portion.

### BACKGROUND

In semiconductor field, a cabinet apparatus includes a cabinet, and the cabinet may accommodate a plurality of purifier filters. However, conventional cabinet apparatus is not allowed to be provided with more purifier filters due to an insufficient or limited space of the cabinet.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a schematic diagram of a cabinet apparatus according to an embodiment of the present disclosure;

FIG. 2 illustrates a schematic diagram of a circuit of a cabinet apparatus according to another embodiment of the present disclosure;

FIG. 3 illustrates a schematic diagram of a circuit of a cabinet apparatus according to another embodiment of the present disclosure;

FIG. 4 illustrates a schematic diagram of a connection relationship of the original purifier filters and the added purifier filter of the cabinet apparatus;

FIGS. 5 and 6 illustrate schematic diagrams of the filter installation bracket in FIG. 1 viewed from different viewing angle (the added purifier filters are not illustrated in FIG. 5);

FIG. 7 illustrates a schematic diagram of a cross-sectional view of the filter installation bracket in FIG. 5 along a direction 7-7′; and

FIG. 8 illustrates a schematic diagram of a cross-sectional view of the filter installation bracket in FIG. 5 along a direction 8-8′.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

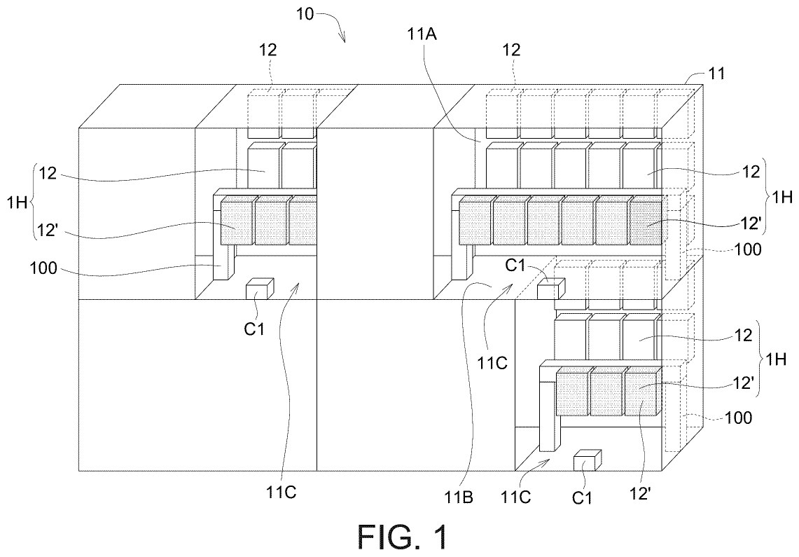

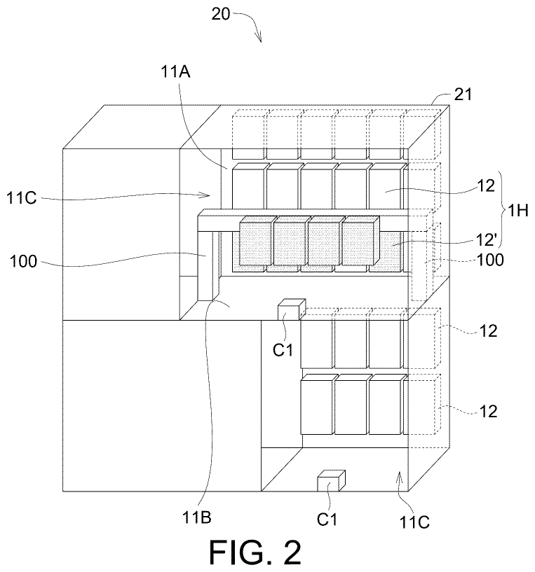

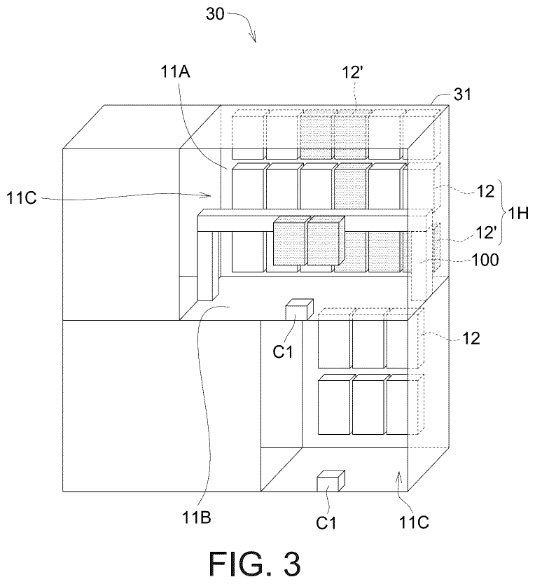

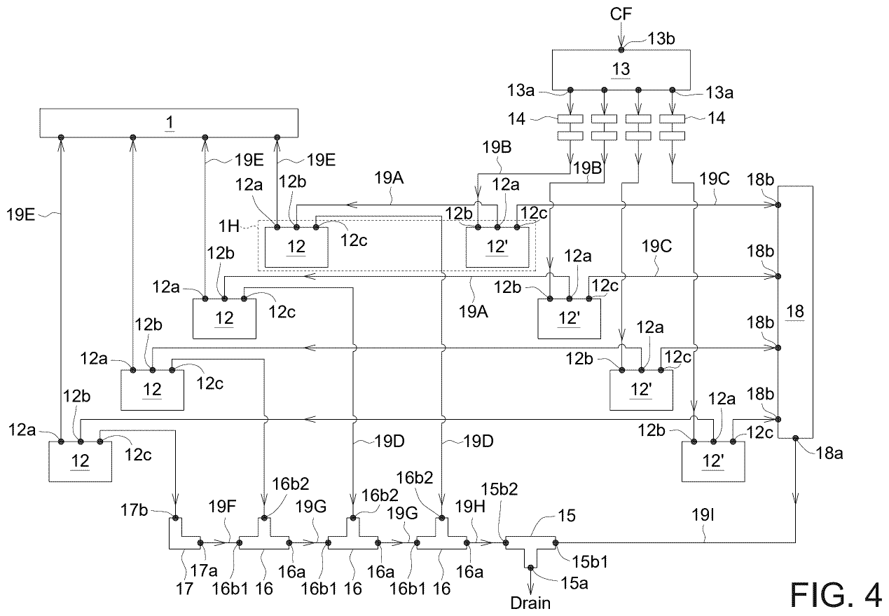

Referring to FIGS. 1 to 4, FIG. 1 illustrates a schematic diagram of a cabinet apparatus 10 according to an embodiment of the present disclosure, FIG. 2 illustrates a schematic diagram of a circuit of a cabinet apparatus 20 according to another embodiment of the present disclosure, FIG. 3 illustrates a schematic diagram of a circuit of a cabinet apparatus 30 according to another embodiment of the present disclosure, and FIG. 4 illustrates a schematic diagram of a connection relationship of the original purifier filters 12 and the added purifier filter 12′ of the cabinet apparatus (10, 20 or 30).

As illustrated in FIG. 1, the cabinet apparatus 10 includes a cabinet 11 and at least one filter installation bracket 100. A plurality of original purifier filters 12 and a plurality of added purifier filters 12′ are disposed on the cabinet 11 for supplying a filtered chemical fluid to at least one semiconductor processing equipment 1 (as illustrated in FIG. 4) for at least one semiconductor process. The original purifier filter 12 and the added purifier filter 12 may include the same structure or similar structure. The added purifier filters 12′ may be disposed on the cabinet 11 through the filter installation bracket 100. In the present embodiment, all added purifier filters 12′ may be disposed on three installation brackets 100. For example, three added purifier filters 12′ are disposed one of the installation brackets 100, six added purifier filters 12′ are disposed another of the installation brackets 100, and three added purifier filters 12′ are disposed the other of the installation brackets 100. In another embodiment, one or some of the added purifier filters 12′ may be disposed on the installation wall (or lateral wall) 11A of the cabinet 11 (if there is enough spacer in the installation wall 11A), and others of the added purifier filters 12′ may be disposed on the installation bracket 100.

The purifier filters (12 or 12′) may capture the ion of the chemical fluid. The chemical fluid is, for example, TMAH (tetramethylammonium hydroxide), photoresist cleaning fluid (for example, CR-168), etc. The added purifier filter 12′ may be connected with the corresponding original purifier filter 12, and the chemical fluid may flow through the connected original purifier filter 12 and added purifier filter 12′ to be filtered. In an embodiment, one of the added purifier filters 12′ and one of the original purifier filters 12 may constitute one filter unit (or called 1 H). Compared to one filter unit with only one original purifier filter 12 (that is, without the added purifier filter 12′), one filter unit with the original purifier filter 12 and the added purifier filter 12′ may increase the capturing rate for the ions (for example, metal ion, or complex ion) of the chemical fluid. In addition, the filter size of the purifier is 50 nm, and the purifier filter may capture the metal ion by chemical chelation on the UPE filter. For example, according to an test result, the capturing rate for TMAH cone may increase by 52%, and the capturing rate for the photoresist cleaning fluid (for example, CR-168) cone may increase by 53%.

As illustrated in FIG. 1, the cabinet 11 includes at least one installation wall 11A, at least one partition 11B and at least one accommodation region 11C, wherein the partitions 11B may divide the space of the cabinet 11 into the at least one accommodation regions 11C. The original purifier filters 12 and the added purifier filters 12′ may be disposed in at least one of the accommodation regions 11C, wherein the original purifier filters 12 may be disposed on the installation wall 11A, and at least one of the added purifier filters 12′ may be disposed on at least one filter installation bracket 100 while the others of the added purifier filters 12′ may be disposed on at least one installation wall 11A of the cabinet 11.

The aforementioned semiconductor processing equipment 1 is, for example, extreme ultraviolet (EVU) lithography equipment, IMM equipment (for example, immersion lithography equipment), etc.

As illustrated in FIG. 1, in the present embodiment, the semiconductor processing equipment is, for example, EVU lithography equipment. The EVU lithography equipment requires twelve filter units (or called 12 H), wherein each filter unit includes one original purifier filter 12 and one added purifier filter 12′.

In twelve filter units, the twelve original purifier filters 12 may be disposed or directly disposed on at least one installation wall 11A of the cabinet 11, the twelve added purifier filters 12′ may be indirectly disposed on the cabinet 11 through the filter installation bracket 100, and each of the added purifier filters 12′ is connected with the corresponding one original purifier filter 12 through at least one tube (not illustrated). Due to the filter installation bracket 100, the added purifier filters 12′ may be added without an additional cabinet 11. Furthermore, if there is no filter installation bracket 100, the added purifier filters 12′ can't be added in the cabinet 11 due to insufficient area of the installation wall 11A in the cabinet 11.

In addition, the cabinet apparatus 10 further includes at least one optical detector C1 facing the filters (for example, the original purifier filters 12 and/or the added purifier filters 12′) for detecting a damage condition of an internal structure of the filter. In an embodiment, the optical detector C1 may be a camera, for example, a X-ray residual stress analyzer. The optical detector C1 may capture an image of the internal structure of the filter and determine the damage extent of the internal structure of the filter according to the color distribution of the image. For example, when the color distribution of the image presents a first color (for example, green), the damage extent of the internal structure of the filter is a first damage extent (for example, minor damage). When the color distribution of the image presents a second color (for example, yellow), the damage extent of the internal structure of the filter is a second damage extent (for example, moderate damage). When the color distribution of the image presents a third color (for example, red), the damage extent of the internal structure of the filter is a third damage extent (for example, severe damage).

As illustrated in FIG. 2, the cabinet apparatus 20 includes a cabinet 21 and at least one filter installation bracket 100. A plurality of the original purifier filters 12 and a plurality of the added purifier filters 12 are disposed on the cabinet 21 for supplying the filtered chemical fluid to at least one semiconductor processing equipment 1 (as illustrated in FIG. 4). At least one of the added purifier filters 12′ may be disposed on the cabinet 21 through the filter installation bracket 100. In the present embodiment, four added purifier filters 12′ may be disposed on the installation wall 11A of the cabinet 21, and four added purifier filters 12′ may be disposed on the filter installation bracket 100 due to insufficient area of the installation wall 11A in the cabinet 21. As illustrated in FIG. 2, in the present embodiment, the semiconductor processing equipment is, for example, IMM equipment. The IMM equipment requires eight filter units (or called 8 H), wherein each filter unit includes one original purifier filter 12 and one added purifier filter 12′. The eight original purifier filters 12 may be disposed or directly disposed on the installation wall 11A of the cabinet 21, the eight added purifier filters 12′ may be indirectly disposed on the cabinet 21 through the filter installation bracket 100, and each of the added purifier filters 12′ is connected with the corresponding one original purifier filter 12 through at least one tube (not illustrated). Due to the filter installation bracket 100, added purifier filter 12′ may be added without an additional cabinet 21. Furthermore, if there is no filter installation bracket 100, the additional cabinet 21 is required to be added; however, such a situation may not be allowed due to insufficient space of the cabinet 21.

As illustrated in FIG. 3, the cabinet apparatus 30 includes a cabinet 31 and at least one filter installation bracket 100. The original purifier filters 12 are disposed on the cabinet 31 for supplying a filtered chemical fluid to at least one semiconductor processing equipment 1 (as illustrated in FIG. 4). At least one of the added purifier filters 12′ may be disposed on the cabinet 31 through the filter installation bracket 100. In the present embodiment, six added purifier filters 12′ may be disposed on the installation wall 11A of the cabinet 31 due to enough area of the installation wall 11A in the cabinet 31, and two added purifier filters 12′ are required to be disposed on the filter installation bracket 100 due to insufficient area of the installation wall 11A in the cabinet 31.

As illustrated in FIG. 3, in the present embodiment, the semiconductor processing equipment is, for example, IMM equipment. The IMM equipment requires eight filter units (or called 8 H), wherein each filter unit includes one original purifier filter 12 and one added purifier filter 12′. The eight original purifier filters 12 may be disposed or directly disposed on the installation wall 11A of the cabinet 31, six added purifier filters 12′ may be disposed or directly disposed on the installation wall 11A of the cabinet 31, two added purifier filters 12′ may be indirectly disposed on the cabinet 31 through the filter installation bracket 100, and each of the added purifier filters 12′ is connected with the corresponding one original purifier filter 12 through at least one tube (not illustrated). Due to the filter installation bracket 100, added purifier filter 12′ may be added without an additional cabinet 31. Furthermore, if there is no filter installation bracket 100, the additional cabinet 31 is required to be added; however, such a situation may not be allowed due to insufficient space of the cabinet 31.

As described above, each filter unit may include at least one original purifier filter 12 and at least one added purifier filter 12′. At least one of the added purifier filters 12′ of all filter units may be indirectly disposed on the installation wall of the cabinet through the filter installation bracket 100. As a result, the added purifier filters 12′ may be disposed on the cabinet without occupying the installation wall of the cabinet. In addition, at least one of the added purifier filters 12′ may be disposed on at least one filter installation bracket 100. In addition, depending on the requirement of the semiconductor processing equipment 1, the number of the filter units is not limited in the present disclosure.

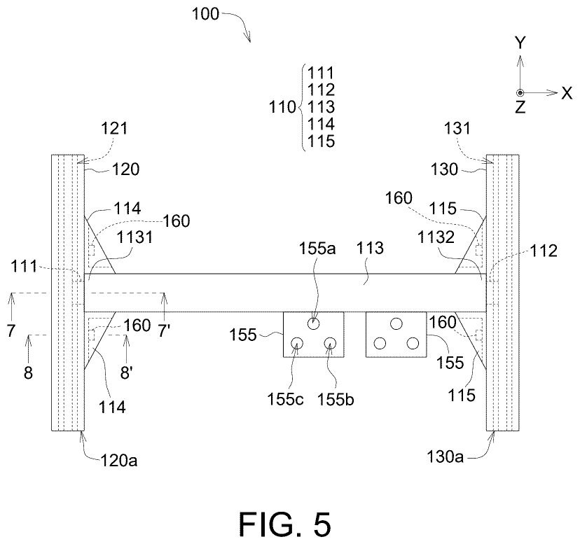

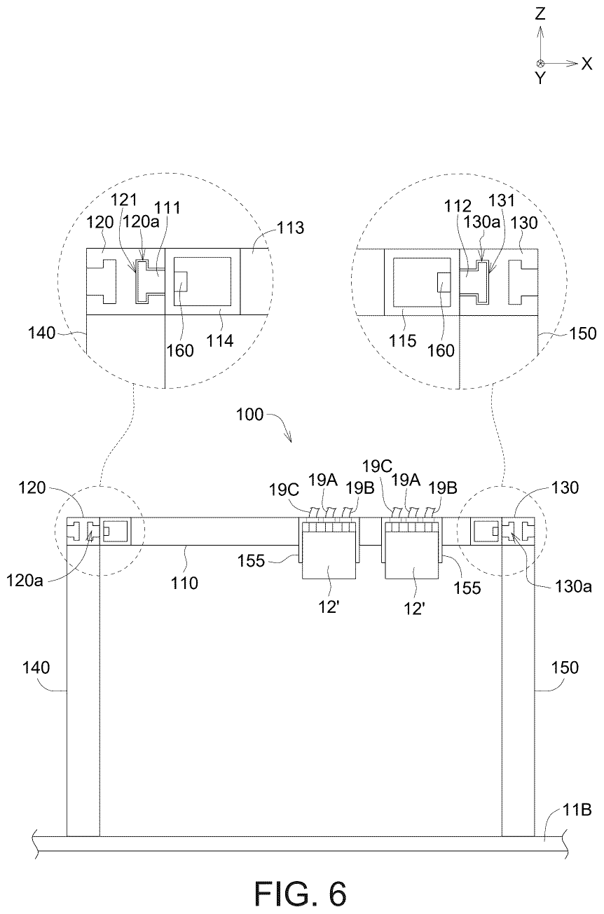

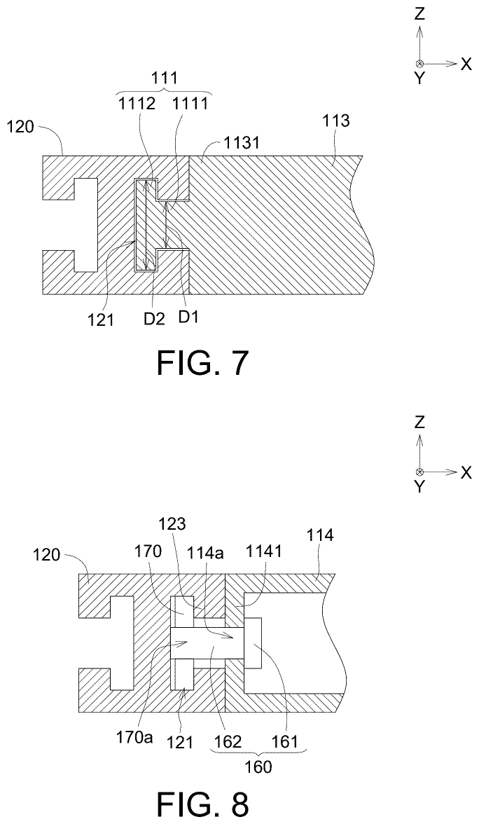

Referring to FIGS. 5 to 8, FIGS. 5 and 6 illustrate schematic diagrams of the filter installation bracket 100 in FIG. 1 viewed from different viewing angle (the added purifier filters 12′ are not illustrated in FIG. 5), FIG. 7 illustrates a schematic diagrams of a cross-sectional view of the filter installation bracket 100 in FIG. 5 along a direction 7-7′, and FIG. 8 illustrates a schematic diagrams of a cross-sectional view of the filter installation bracket 100 in FIG. 5 along a direction 8-8′.

As illustrated in FIG. 4, each purifier filter (12 or 12′) includes an outlet 12a, an inlet 12b and a vent 12c. The filter installation bracket 100 further includes at least one pump 13, at least one fitting 14, a first three-way connector 15, at least one second three-way connector 16, a two-way connector 17, a drain manifold 18, a plurality of tubes (for example, 19A to 19I).

As illustrated in FIGS. 1 and 4, the pump 13 may be disposed in the cabinet 11, for example. The pump 13 includes at least one outlet 13a and an input 13b. The fitting 14 is, for example, adaptor, and configured to connect the pump 13 with the added purifier filters 12′. The first three-way connector 15 includes an outlet 15a, a first inlet 15b1 and a second inlet 15b2. Each second three-way connector 16 includes an outlet 16a, a first inlet 16b1 and a second inlet 16b2. The two-way connector 17 includes an outlet 17a and an inlet 17b. The drain manifold 18 includes an outlet 18a and at least one inlet 18b.

As illustrated in FIG. 4, in the present embodiment, the number of the outlets 13a of the pump 13 is four, even more or less. The number of the outlets 13a may be equal to that of the number of the added purifier filters 12′. The chemical fluid CF may be supplied to the pump 13 through the input 13b. The pump 13 may transmit the chemical fluid CF to the outlets 13a. Each outlet 13a of the pump 13 connects the inlet 12b of the corresponding added purifier filter 12′ through the corresponding fitting 14. The outlet 12a of each added purifier filter 12′ connects the inlet 12b of the corresponding original purifier filter 12. The inlet 12b of each added purifier filter 12′ connects the corresponding output 13a of the pump 13. The vent 12c of each added purifier filter 12′ connects the corresponding inlet 18b of the drain manifold 18. The outlet 18a of the drain manifold 18 is connected the first inlet 15b1 of the first three-way connector 15, and the chemical fluid CF with bubble may be drained from the outlet 15a of the first three-way connector 15. The drain manifold 18 further includes a value (not illustrated). When the bubble in the chemical fluid CF is needed be drained, the pump 13 stops pumping, the value of the drain manifold 18 may be turned on. When the filtered chemical fluid is supplied to at least one semiconductor processing equipment 1, the pump 13 pumps, and the value of the drain manifold 18 may be turned off.

As illustrated in FIG. 4, the second three-way connectors 16 may be connected in series. Furthermore, in adjacent two the second three-way connectors 16, the outlet 16a of one of the two second three-way connectors 16 is connected with the first inlet 16b1 of the other of the two second three-way connectors 16. The outlet 17a of the two-way connector 17 is connected with the first inlet 16b1 of one of the second three-way connectors 16. The second inlet 16b2 of each of the second three-way connectors 16 is connected with the vent 12c of the corresponding original purifier filter 12, and the inlet 17b of the two-way connector 17 is connected with the vent 12c of an end one of the original purifier filters 12. The outlet 16a of an end one of the second three-way connectors 16 is connected with the second inlet 15b2 of the first three-way connector 15. As a result, the chemical fluid CF with bubble may be drained from the outlet 15a of the first three-way connector 15 through the second three-way connectors 16 and the two-way connector 17.

As described above, the bubble in the chemical fluid CF within the added purifier filters 12′ and the original purifier filters 12 may be drained through the same drain outlet, for example, the outlet 15a of the first three-way connector 15.

As illustrated in FIGS. 4, 5 and 6, the added purifier filters 12′ may be disposed on the filter holder 155. The filter holder 155 may be fixed to the filter installation bracket. The filter holder 155 has an outlet hole 155a, an inlet hole 155b and a vent hole 155c for allowing at least one tube to pass through. The first tube 19A connects the outlet 12a of the added purifier filter 12′ with the inlet 12b of the corresponding original purifier filter 12. The first tube 19A may pass through the outlet hole 155a of the filter holder 155 to connect the inlet 12b of the corresponding original purifier filter 12. The second tube 19B connects the inlet 12b of the added purifier filter 12′ with the corresponding outlet 13a of the pump 13. The second tube 19B may pass through the inlet hole 155b of the filter holder 155 to connect the corresponding outlet 13a of the pump 13. The third tube 19C connects the vent 12c of the added purifier filter 12′ with the corresponding inlet 18b of the drain manifold 18. The third tube 19C may pass through the vent hole 155c of the filter holder 155 to connect the corresponding inlet 18b of the drain manifold 18.

As illustrated in FIG. 4, the vent 12c of each original purifier filter 12 may be connected with the second inlet 16b2 of the corresponding second three-way connector 16 through at least one tube 19D, the output 12a of each original purifier filter 12 may be connected with the corresponding semiconductor processing equipment 1 through at least one tube 19E, the output 17a of the two-way connector 17 may be connected with the first inlet 16b1 of one of the second three-way connectors 16 through at least one tube 19F, the outlet 16a of one of the second three-way connectors 16 may be connected with the first inlet 16b1 of the adjacent second three-way connector 16 through at least one tube 19G, the outlet 16a of the end one of the second three-way connectors 16 may be connected with the second inlet 15b2 of the first three-way connector 15 through at least one tube 19H, and the first inlet 15b1 of the first three-way connector 15 may be connected with the outlet 18a of the drain manifold 18 through at least one tube 19I.

As illustrated in FIGS. 5 and 6, the filter installation bracket 100 further includes a first linkage 110, a second linkage 120, a third linkage 130, a fourth linkage 140, a fifth linkage 150, at least one fixing component 160 (the fixing component 160 is illustrated in FIG. 8) and at least one fastener 170 (the fastener 170 is illustrated in FIG. 8). The first linkage 110, the second linkage 120, the third linkage 130, the fourth linkage 140 and the fifth linkage 150 may be formed of a metal including, for example, aluminum (Al), etc. At least one of the first linkage 110, the second linkage 120, the third linkage 130, the fourth linkage 140 and the fifth linkage 150 may be formed by, for example, an extrusion, a machining, a mechanical forging or a combination.

As illustrated in FIGS. 5 and 6, the filter holder 155 may be fixed to the first linkage 110 through, for example, screw or snap. In an embodiment, the first linkage 110 may be disposed in X-axis (for example, a longitudinal axis of the first linkage 110 is parallel to the X-axis), the second linkage 120 and the third linkage 130 may be disposed in Y-axis (for example, a longitudinal axis of each of these linkages is parallel to the Y-axis), and the fourth linkage 140 and the fifth linkage 150 may be disposed in Z-axis (for example, a longitudinal axis of each of these linkages is parallel to the Z-axis), wherein the X-axis (for example, first axis), the Y-axis (for example, second axis) and the Z-axis (for example, third axis) may be perpendicular to each other.

As illustrated in FIGS. 5 to 8, the first linkage 110 include a first sliding portion 111, a third sliding portion 112, a first linkage body 113, at least one first fixing portion 114 and at least one second fixing portion 115. The second linkage 120 includes a second sliding portion 121. The first sliding portion 111 is slidably connected with the second sliding portion 121, and the first linkage 110 may slide relative to the second linkage 120 in Y-axis for conveniently adjusting the position of the added purifier filter 12′ in Y-axis (also called “drawer-type bracket”) and/or replacing the purifier filter (12 and/or 12′). Furthermore, the original purifier filters 12 in rear of the added purifier filters 12′ may be conveniently replaced by adjusting the position of the first linkage 110. In an embodiment, the first sliding portion 111 is a protrusion, and the second sliding portion 121 is a groove, wherein the protrusion may be disposed within the groove. The first fixing portions 114 and the second fixing portions 115 may be fixed to the first linkage body 113.

As illustrated in FIGS. 5 to 8, the first linkage body 113 includes a first end portion 1131 and a second end portion 1132 opposite to the first end portion 1131. The first sliding portion 111 and the third sliding portion 112 are disposed on the first end portion 1131 and the second end portion 1132 respectively. Furthermore, the first sliding portion 111 is protruded relative to an end surface of the first end portion 1131, and the second sliding portion 112 is protruded relative to an end surface of the second end portion 1132. The first sliding portion 111 includes a sliding segment 1111 and a connection segment 1112. The connection segment 1112 connects the first end portion 1131 of the first linkage body 113 with the sliding segment 1111. In an embodiment, the connection segment 1112 and the sliding segment 1111 may form a T-shape structure. Furthermore, the connection segment 1111 has a first outer diameter D1, and the sliding segment has a second outer diameter D2, wherein the second outer diameter D2 is greater than the first outer diameter D1. As a result, it is not easy for the first linkage 110 to be separated from the second linkage 120. In addition, the second sliding portion 121 has a shape matching that of the first sliding portion 111. In addition, the second linkage 120 has an opening 120a which allows the first sliding portion 111 to enter or separated from the second sliding portion 121 of the second linkage 120.

As illustrated in FIGS. 5 to 8, the third linkage 130 includes a fourth sliding portion 131. The third sliding portion 112 is slidably connected with the fourth sliding portion 131, and the first linkage 110 may slide relative to the third linkage 130 in Y-axis for adjusting the position of the added purifier filter 12′ in Y-axis and/or replacing the purifier filter (12 and/or 12′). In an embodiment, the third sliding portion 112 is a protrusion, and the fourth sliding portion 131 is a groove, wherein the protrusion may be disposed within the groove. The third sliding portion 112 of the first linkage 110 includes the structure the same as or similar to that of the first sliding portion 111, the fourth sliding portion 131 of the third linkage 130 includes the structure the same as or similar to that of the second sliding portion 121 of the second linkage 120, and the similarities is not repeated here. The third linkage 130 has an opening 130a which allows the third sliding portion 112 to enter or separated from the fourth sliding portion 131 of the third linkage 130.

As illustrated in FIGS. 5 to 6, the fourth linkage 140 connects with the second linkage 120 and is fixed to the partition 11B (as illustrated in FIG. 1) of the cabinet 11. The second linkage 120 may be fixed to the fourth linkage 140. The fifth linkage 150 connects with the third linkage 130 and is fixed to the partition 11B of the cabinet 11. The third linkage 130 may be fixed to the fifth linkage 150.

As illustrated in FIGS. 5 to 8, the first linkage 110 is detachably connected with the second linkage 120 and the third linkage 130 through the fixing components 160 and the fasteners 170. Furthermore, the fixing component 160 may temporarily fix the relative position between the first linkage 110 with the second linkage 120 and the relative position between the first linkage 110 with the third linkage 130. In the present embodiment, the fixing component 160 is, for example, a bolt, and the fixing component 160 may be screwed to the fastener 170 through a through hole 114a of the first fixing portion 114, the second sliding portion 121 of the second linkage 120. The fixing component 160 includes a head 161 and a fixing portion 162 connected with the head 161, wherein the head 161 has outer diameter greater than that of the fixing portion 162, and the fixing portion 162 has male thread. The fastener 170 is, for example, a nut with female thread. The fastener 170 may be restricted by a sidewall of the second sliding portion 121 and thus can't rotate relative to the second sliding portion 121 (that is, the rotational freedom of the fastener 170 is restricted). As a result, when the fixing portion 162 of the fixing component 160 is screwed to the fastener 170, the fastener 170 may move in +X-axis (toward the head 161 of the fixing component 160) due to the rotational freedom of the fastener 170 being restricted, and thus the head 161 of the fixing component 160 and the fastener 170 may clamp the sidewall 1141 of the first fixing portion 114 and a sidewall 123 of the second linkage 120 for fixing the relative position between the first linkage 110 with the second linkage 120 (or the fourth linkage 130).

Similarly, the second fixing portion 115 and the third linkage 130 include the features the same as or similar to that of the first fixing portion 114 and the second linkage 120 respectively, and it will not repeated here. The fixing component 160 may fix the relative position between the first linkage 110 with the third linkage 130 (or the fifth linkage 150) in the same or similar way.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

According to the present disclosure, a filter installation bracket includes a first linkage and a second linkage. The first linkage is configured to fix a filter holder and comprising a first sliding portion. The second linkage includes a second sliding portion. The second sliding portion is slidably connected with the first sliding portion. As a result, the first linkage may slide relative to the second linkage for conveniently adjusting the position of the added purifier filter and/or replacing the purifier filter.

Example embodiment 1: a filter installation bracket includes a first linkage and a second linkage. The first linkage is configured to fix a filter holder and comprising a first sliding portion. The second linkage includes a second sliding portion. The second sliding portion is slidably connected with the first sliding portion.

Example embodiment 2 based on Example embodiment 1: the first linkage further includes a third sliding portion, and the filter installation bracket further includes a third linkage, including a fourth sliding portion. The third sliding portion is slidably connected with the fourth sliding portion.

Example embodiment 3 based on Example embodiment 2: the first linkage further includes a first linkage body, including a first end portion and a second end portion opposite to the first end portion. The first sliding portion and the third sliding portion are disposed on the first end portion and the second end portion respectively.

Example embodiment 4 based on Example embodiment 1: the first linkage includes a first linkage body, the first sliding portion is disposed on the first linkage body, and the first sliding portion includes a sliding segment and a connection segment. The connection segment connects the first linkage body with the sliding segment. The connection segment has a first outer diameter, the sliding segment has a second outer diameter, and the second outer diameter is greater than the first outer diameter.

Example embodiment 5 based on Example embodiment 4: sliding segment and the connection segment form a T-shaped structure.

Example embodiment 6 based on Example embodiment 1: the first sliding portion is a protrusion, the second sliding portion is a groove, and the second linkage has an opening which allows the protrusion to enter the groove.

Example embodiment 7 based on Example embodiment 1: the filter installation bracket further includes a fourth linkage and a fifth linkage. The fourth linkage is connected with the second linkage and configured to be fixed to a partition of a cabinet. The fifth linkage is connected with the third linkage and configured to be fixed to the partition of the cabinet.

Example embodiment 8: a filter installation bracket includes a first linkage and a second linkage. The first linkage is configured to fix a filter holder, extends in a first axis, and includes a first sliding portion. The second linkage extends in a second axis and includes a second sliding portion extending in the second axis. The first linkage and the second linkage are slidably connected in the second axis through the second sliding portion and the first sliding portion.

Example embodiment 9 based on Example embodiment 8: the first linkage further includes a third sliding portion, and the filter installation bracket further includes a third linkage. The third linkage extends in the second axis and includes a fourth sliding portion. The first linkage and the third linkage are slidably connected in the second axis through the third sliding portion and the fourth sliding portion.

Example embodiment 10 based on Example embodiment 9: the first linkage includes a first linkage body. The first linkage body includes a first end portion and a second end portion opposite to the first end portion. The first sliding portion and the third sliding portion are disposed on the first end portion and the second end portion respectively.

Example embodiment 11 based on Example embodiment 8: the first linkage includes a first linkage body, the first sliding portion is disposed on the first linkage body, and the first sliding portion includes a sliding segment and a connection segment. The connection segment connects the first linkage body with the sliding segment. The connection segment has a first outer diameter, the sliding segment has a second outer diameter, and the second outer diameter is greater than the first outer diameter.

Example embodiment 12 based on Example embodiment 11: the sliding segment and the connection segment form a T-shaped structure.

Example embodiment 13 based on Example embodiment 8: the first sliding portion is a protrusion, the second sliding portion is a groove, and the second linkage has an opening which allows the protrusion to enter the groove.

Example embodiment 14 based on Example embodiment 8: the filter installation bracket further includes a fourth linkage and a fifth linkage. The fourth linkage extends in a third axis, is connected with the second linkage and configured to be fixed to a partition of a cabinet. The fifth linkage extends in a third axis, is connected with the third linkage and configured to be fixed to the partition of the cabinet.

Example embodiment 15: a cabinet apparatus includes a cabinet and a filter installation bracket. The filter installation bracket is disposed in the cabinet and includes a first linkage and a second linkage. The first linkage is configured to fix a filter holder and includes a first sliding portion. The second linkage includes a second sliding portion. The second sliding portion is slidably connected with the first sliding portion.

Example embodiment 16 based on Example embodiment 15: the first linkage further includes a third sliding portion, a first end portion and a second end portion opposite to the first end portion, and the filter installation bracket further includes a third linkage. The third linkage includes a fourth sliding portion, wherein the fourth sliding portion is slidably connected with the third sliding portion. The first sliding portion and the third sliding portion are disposed on the first end portion and the second end portion respectively.

Example embodiment 17 based on Example embodiment 15: the first linkage includes a first linkage body, the first sliding portion is disposed on the first linkage body, and the first sliding portion includes a sliding segment and a connection segment. The connection segment connects the first linkage body with the sliding segment. The connection segment has a first outer diameter, the sliding segment has a second outer diameter, and the second outer diameter is greater than the first outer diameter.

Example embodiment 18 based on Example embodiment 17: the sliding segment and the connection segment form a T-shaped structure.

Example embodiment 19 based on Example embodiment 15: the first sliding portion is a protrusion, the second sliding portion is a groove; the second linkage has an opening which allows the protrusion to enter the groove.

Example embodiment 20 based on Example embodiment 15: the cabinet apparatus further includes a fourth linkage and a fifth linkage. The fourth linkage is connected with the second linkage and configured to be fixed to a partition of a cabinet. The fifth linkage is connected with the third linkage and configured to be fixed to the partition of the cabinet.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A filter installation bracket, comprising:
a first linkage, configured to fix a filter holder and comprising a first sliding portion; and
a second linkage, comprising a second sliding portion;
wherein the second sliding portion is slidably connected with the first sliding portion.

2. The filter installation bracket according to claim 1, wherein the first linkage further comprises a third sliding portion, and the filter installation bracket further comprises:
a third linkage, comprising a fourth sliding portion;
wherein the third sliding portion is slidably connected with the fourth sliding portion.

3. The filter installation bracket according to claim 2, wherein the first linkage further comprises:
a first linkage body, comprising a first end portion and a second end portion opposite to the first end portion;
wherein the first sliding portion and the third sliding portion are disposed on the first end portion and the second end portion respectively.

4. The filter installation bracket according to claim 1, wherein the first linkage comprises a first linkage body, the first sliding portion is disposed on the first linkage body, and the first sliding portion comprises:
a sliding segment; and
a connection segment, connecting the first linkage body with the sliding segment;
wherein the connection segment has a first outer diameter, the sliding segment has a second outer diameter, and the second outer diameter is greater than the first outer diameter.

5. The filter installation bracket according to claim 4, wherein the sliding segment and the connection segment form a T-shaped structure.

6. The filter installation bracket according to claim 1, wherein the first sliding portion is a protrusion, the second sliding portion is a groove, and the second linkage has an opening which allows the protrusion to enter the groove.

7. The filter installation bracket according to claim 1, further comprising:
a fourth linkage, connected with the second linkage and configured to be fixed to a partition of a cabinet; and
a fifth linkage, connected with the third linkage and configured to be fixed to the partition of the cabinet.

8. A filter installation bracket, comprising:
a first linkage, configured to fix a filter holder, extending in a first axis, and comprising a first sliding portion; and
a second linkage, extending in a second axis and comprising a second sliding portion extending in the second axis;
wherein the first linkage and the second linkage are slidably connected in the second axis through the second sliding portion and the first sliding portion.

9. The filter installation bracket according to claim 8, wherein the first linkage further comprises a third sliding portion, and the filter installation bracket further comprises:
a third linkage, extending in the second axis and comprising a fourth sliding portion;
wherein the first linkage and the third linkage are slidably connected in the second axis through the third sliding portion and the fourth sliding portion.

10. The filter installation bracket according to claim 9, wherein the first linkage comprises:
a first linkage body, comprising a first end portion and a second end portion opposite to the first end portion;
wherein the first sliding portion and the third sliding portion are disposed on the first end portion and the second end portion respectively.

11. The filter installation bracket according to claim 8, wherein the first linkage comprises a first linkage body, the first sliding portion is disposed on the first linkage body, and the first sliding portion comprises:
a sliding segment; and
a connection segment, connecting the first linkage body with the sliding segment;
wherein the connection segment has a first outer diameter, the sliding segment has a second outer diameter, and the second outer diameter is greater than the first outer diameter.

12. The filter installation bracket according to claim 11, wherein the sliding segment and the connection segment form a T-shaped structure.

13. The filter installation bracket according to claim 8, wherein the first sliding portion is a protrusion, the second sliding portion is a groove, and the second linkage has an opening which allows the protrusion to enter the groove.

14. The filter installation bracket according to claim 8, further comprising:
a fourth linkage, extending in a third axis, connected with the second linkage and configured to be fixed to a partition of a cabinet; and
a fifth linkage, extending in a third axis, connected with the third linkage and configured to be fixed to the partition of the cabinet.

15. A cabinet apparatus, comprising:
a cabinet; and
a filter installation bracket, disposed in the cabinet and comprising:
a first linkage, configured to fix a filter holder and comprising a first sliding portion; and
a second linkage, comprising a second sliding portion;
wherein the second sliding portion is slidably connected with the first sliding portion.

16. The cabinet apparatus according to claim 15, wherein the first linkage further comprises a third sliding portion, a first end portion and a second end portion opposite to the first end portion, and the filter installation bracket further comprises:
a third linkage, comprising a fourth sliding portion, wherein the fourth sliding portion is slidably connected with the third sliding portion;
wherein the first sliding portion and the third sliding portion are disposed on the first end portion and the second end portion respectively.

17. The cabinet apparatus according to claim 15, wherein the first linkage comprises a first linkage body, the first sliding portion is disposed on the first linkage body, and the first sliding portion comprises:
a sliding segment; and
a connection segment, connecting the first linkage body with the sliding segment;
wherein the connection segment has a first outer diameter, the sliding segment has a second outer diameter, and the second outer diameter is greater than the first outer diameter.

18. The cabinet apparatus according to claim 17, wherein the sliding segment and the connection segment form a T-shaped structure.

19. The cabinet apparatus according to claim 15, wherein the first sliding portion is a protrusion, the second sliding portion is a groove; the second linkage has an opening which allows the protrusion to enter the groove.

20. The cabinet apparatus according to claim 15, further comprising:
a fourth linkage, connected with the second linkage and configured to be fixed to a partition of a cabinet; and
a fifth linkage, connected with the third linkage and configured to be fixed to the partition of the cabinet.
